(19) United States
(12) Patent Application Publication
(10) Pub. No.: US 2014/0156435 A1
(43) Pub. Date: Jun. 5, 2014

(54) PROVIDING MONEY TRANSFER USING A MONEY TRANSFER PLATFORM

(71) Applicant: PANGEA UNIVERSAL HOLDINGS, INC., CHICAGO, IL (US)

(72) Inventors: Rahier Rahman, Chicago, IL (US); Carson Junginger, Chicago, IL (US)

(73) Assignee: PANGEA UNIVERSAL HOLDINGS, INC., CHICAGO, IL (US)

(21) Appl. No.: 14/095,844

(22) Filed: Dec. 3, 2013

Related U.S. Application Data
(60) Provisional application No. 61/733,028, filed on Dec. 4, 2012.

(51) Int. Cl. G06Q 20/10; G06Q 20/20; G06Q 20/38; G06Q 20/40

(52) U.S. Cl. CPC G06Q 20/10; G06Q 20/40; G06Q 20/202; G06Q 20/385
USPC 705/21; 705/44; 705/39

(57) ABSTRACT

The present disclosure describes methods, systems, and computer program products for providing funds transfer over an existing retail payment system using a money transfer platform. One method includes receiving a funds transfer request associated with a funds pack for transferring funds from a first location to a receiver in a second location, requesting validation of a unique identifier associated with the funds pack from a first-location payment network provider, receiving a validation success notification responsive to the requested validation of a unique identifier from the first payment network provider, generating a termination identifier identifying the funds transfer transaction request, transmitting the termination identifier to the receiver, providing instructions causing funds to be paid to the receiver upon presentation of the termination identifier, and receiving a request for funds from a second-location payment network provider, the request for funds associated with payment of funds based on presentation of the termination identifier.

### CROSS REFERENCE TO RELATED APPLICATIONS

This application is related to and claims priority to U.S. Provisional Patent Application No. 61/733,028, entitled “System and Method for Peer-to-Peer Funds Transfer,” filed Dec. 4, 2012, which is hereby incorporated by reference for all purposes.

### BACKGROUND

Electronic money transfer (also referred to herein as electronic funds transfer or EFT for short) has been widely available for many years. For example, a sender requests his bank to wire a certain amount of money to a receiver. The sender can initiate such funds transfer by physically visiting the bank, or using a web interface provided by the bank. The conventional electronic funds transfer presents numerous problems, including that bank-operated electronic funds transfer is very expensive. Fund-in (also referred to herein as “money-in” and/or “cash-in”) and fund-out (also referred to herein as “money-out” and/or “cash-out”) options also require bank accounts. However, big portions of most countries' population, especially those residing in developing countries or in rural areas of developed countries, do not have bank accounts, credit cards, etc. and remain at a disadvantage compared to those that do. These underbanked people often find it challenging or even impossible to transfer a small amount of money to another person at a low cost.

### SUMMARY

The present disclosure relates to computer-implemented methods, computer-readable media, and computer systems for providing funds transfer over an existing retail payment system using a money transfer platform (MTP).

Conventional electronic funds transfer demands that both the sender and the receiver have bank accounts at banks that support international electronic funds transfer. However, many banks in rural areas of underdeveloped countries likely do not provide an international electronic funds transfer service. Accordingly, underbanked people who lack a sufficient bank account or a credit card are at a disadvantage. The underbanked often use pre-paid cards, some of which can be reloaded with additional funds. Family and friends have the additional inconvenience of sending money to the underbanked. At times, options are to send money through money transfer services, such as Western Union and the like, paying an additional fee, or sending pre-paid cards through the mail, which can get lost and take additional time for the underbanked individual to receive. The sender and the underbanked are both looking for an inexpensive and quick way of sending funds electronically.

In recent years, technologies for transferring money using mobile devices, such as smartphones, have been developed. However, the prior art to date does not disclose a system and method for funds transfer that acts as its own clearing house, does not use third-party processors, requires minimal user interaction, and provides fraud protection. Furthermore, the prior art to date does not disclose seamless software integration into point-of-sale (POS) activation networks within the existing retail payment ecosystem. With wide popularity of mobile phones in underdeveloped rural areas, mobile-phone-based national and international funds transfer using a MTP is thus desirable—where the MTP takes advantage of the existing retail payment systems to provide money transfer services to the underbanked.

In some implementations, the described system and method primarily comprise a multi-platform, MTP money transfer system that provides a low-cost suite of financial service products using website, mobile application and retail locations. The platform acts like a clearing house, in that the platform includes components that handle settlement and reconciliation for the point-of-sale activation (POSA) networks and funds transactions using a credit line. The system also provides a mechanism to seamlessly transfer stored value across retail networks and card programs, providing interconnectivity across prepaid retail networks enabling “closed-loop” systems to speak to each other. To utilize the system's platform on the web or mobile application, consumers may link a mobile phone number and a funding source, such as a prepaid debit card, to an account within the system. To utilize the system's platform at a retail location, consumers will be able to use cash and link a phone number to a transaction.

The sender can initiate a transaction online or through a mobile application. In some such implementations, after logging into the website or mobile application, the sender enters the sender's name, phone number, and password. The sender then enters the receiver's name, phone number, amount of funds to transfer, payment method and a transfer pincode. The information is displayed on a confirmation page which the sender approves to submit the transaction.

The sender can also initiate the transaction at a retail location. In some such implementations, the sender goes to a retail location and informs the sales associate that he would like to transfer funds through the system. The sender provides their name, phone number, amount of funds to transfer, receiver's name, receiver's phone number, and transfer pincode. The sender may then use cash or any other form of payment to fund the transaction. The sales associate enters the information into the system and shows the sender the confirmation page. If the information is correct, the sender approves and submits the transaction.

In some implementations, the system generates a money transfer code (MTC) and sends an email or short message service (SMS) message to the sender and the receiver with the transaction information and the MTC. The sender, for security reasons, then contacts the receiver and gives the receiver the transfer pincode.

If the receiver already has a pre-paid card on file, the funds may be automatically loaded onto that card and are immediately accessible by the receiver. If the receiver has multiple cards on file, the receiver may log into the system's website or mobile application and choose the card on which to load the funds. Once the receiver chooses the card, the funds are immediately accessible. If the receiver does not have a pre-paid card, the receiver can go to their preferred retail location or they can use the retailer location map to find a retail location close to him or her. Once at the retail location, the receiver chooses a pre-paid card and presents the card to the sales associate. The receiver informs the sales associate that he wants to load funds from a transfer onto that card and provides the sales associate with their name, phone number, MTC and transfer pincode. The sales associate enters this information into the system and loads the funds transferred onto the card.

In some implementations, a first computer-implemented method includes receiving a funds transfer transaction request for transferring funds from a first location to a receiver in a second location, the funds transfer transaction request associated with a funds pack credited with an amount of funds, requesting, by operation of a computer, validation of a unique identifier associated with the funds pack from a first payment network provider associated with the first location, receiving, by operation of a computer, a validation success notification responsive to the requested validation of a unique identifier from the first payment network provider, generating, by operation of a computer, a termination identifier identifying the funds transfer transaction request, transmitting the termination identifier to the receiver, providing instructions, by operation of a computer, causing funds to be paid to the receiver upon presentation of the termination identifier, and receiving a request for funds from a second payment network provider associated with the second location, the request for funds associated with payment of funds based on presentation of the termination identifier.

In some implementations, a second computer-implemented method includes receiving an indication of an interest in transferring funds from a sender at a first location to a receiver at a second location, receiving an indication of an initial funds transfer amount in a first currency for transfer to a receiver at the second location, identifying a currency exchange rate value for an exchange of a first currency used at the first location and a second currency used at the second location, converting, using the currency exchange rate, the initial funds transfer amount into an funds receiving amount as measured in the second currency, and communicating the funds receiving amount.

In some implementations, a third computer-implemented method includes receiving from a point-of-sale (POS), by operation of a computer, a code associated with a fund-in transaction, receiving, by operation of a computer, a transfer amount and a unique transfer identifier, transmitting the transfer amount and the unique identifier to a money transfer platform (MTP) transfer service, receiving an activation response from the MTP transfer service, the activation response responsive to the MTP transfer service: validating, by a computer, the identified transfer, activating the transfer, and alerting a receiver uniquely identified by the unique transfer identifier, and transmitting an activation response to the POS.

Other implementations of the first, second, and third method aspects include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

First computer-implemented method:

A first aspect, combinable with the general implementation, further comprising initiating a fund-in process for the funds transfer transaction request using the funds pack.

A second aspect, combinable with any of the previous aspects, further comprising transmitting geographic locations that may be used by the receiver to receive the funds.

A third aspect, combinable with any of the previous aspects, wherein a mobile software application initiates a display of the transmitted geographic locations.

A fourth aspect, combinable with any of the previous aspects, further comprising storing data regarding the termination identifier and data associated with the funds transfer transaction request.

A fifth aspect, combinable with the general implementation, further comprising: receiving the unique identifier associated with the funds pack and an amount of funds to credit to the funds pack, and storing the unique identifier and the amount of funds to credit to the funds pack to a database.

A sixth aspect, combinable with any of the previous aspects, further comprising initiating a funds transfer process to transfer a particular amount of credited funds from the first location to the second location.

A seventh aspect, combinable with any of the previous aspects, further comprising generating instructions to: convert the particular amount of credited funds into a different currency type, and credit the different currency type to the second payment network provider.

Second computer-implemented method:

A first aspect, combinable with the general implementation, further comprising transmitting a funds transfer transaction request to a MTP transfer service, the funds transfer transaction request associated with a funds pack credited with an amount of funds for transfer from the first location to the receiver.

A second aspect, combinable with any of the previous aspects, further comprising initiating a display of geographic locations available for the receiver to receive funds near the second location.

A third aspect, combinable with any of the previous aspects, further comprising initiating a funds transfer transaction request for transferring funds from the first location to the receiver.

A fourth aspect, combinable with any of the previous aspects, wherein the first currency is different than the second currency.

A fifth aspect, combinable with any of the previous aspects, wherein the first location is in a country that is different than the country in which the second location is located

A sixth aspect, combinable with any of the previous aspects, further comprising identifying the currency to be used as the second currency transferred to the receiver at the second location.

Third computer-implemented method:

A first aspect, combinable with the general implementation, wherein the code includes one of a linear code or a matrix code.

A second aspect, combinable with any of the previous aspects, wherein the receiver is uniquely identified by at least one of a telephone number, an address, a government issued identifier, or an employer issued identifier.

A third aspect, combinable with any of the previous aspects, further comprising the POS requesting and receiving the transfer amount responsive to receiving the code.

A fourth aspect, combinable with any of the previous aspects, wherein the POS receives the code from a mobile computing device.

A fifth aspect, combinable with any of the previous aspects, further comprising the POS processing the received code.

A sixth aspect, combinable with any of the previous aspects, wherein the MTP transfer service exposes an application programming interface (API) for receiving a request containing the code.

Certain implementation may provide various advantages. For example, some or all implementations be tailored to enhance the reach and drive the cost of global remittance down by employing scalable software technology that leverages prepaid product activation capabilities across expansive retail networks.

An advantage of some or all implementations is to provide seamless software integration into existing retail locations through their existing point-of-sale terminals, allowing these “closed loop” systems to speak to each other and transfer value between each other.

An advantage of some or all implementations is to provide an “open loop” payment platform that facilitates “open loop” transfer capability across networks and provide anti-money laundering (AML), Office of Foreign Assets Control (OFAC), and compliance support for participating retailers.

An advantage of some or all implementations is to provide a platform that acts like a clearing house, in that the platform includes components that handle settlement and a reconciliation for the POSA networks and funds transactions using a credit line.

An advantage of some or all implementations is to allow a sender to transmit funds to anyone in a few simple steps either online, by SMS message or in person at a retail location.

An advantage of some or all implementations is to allow a recipient to instantaneously redeem the money transfer on a prepaid card.

An advantage of some or all implementations is to provide remote deposit capture that includes the ability to scan an image of a check and deposit funds directly onto a prepaid card, limiting the need to use check cashing locations.

An advantage of some or all implementations is to provide bill pay functionality that supports payments to utilities, water companies, cable providers, department stores, banks, credit card companies and wireless services.

An advantage of some or all implementations is to provide fraud protection and detection services and to deliver convenient, cost-effective, and secure financial service products.

Other advantages of this disclosure will be clear to a person of ordinary skill in the art. It should be understood, however, that a system or method could practice the disclosure while not achieving all of the enumerated advantages, and that the protected disclosure is defined by the claims.

Accordingly, the details of one or more implementations of the subject matter of this specification are set forth in the accompanying drawings and the description below. Other features, aspects, and advantages of the subject matter will become apparent from the description, the drawings, and the claims.

### DESCRIPTION OF THE DRAWINGS

Although the characteristic features of this disclosure will be particularly pointed out in the claims, the detailed description, and the manner in which it may be made and used, may be better understood by referring to the following detailed description taken in connection with the accompanying drawings forming a part hereof, wherein like reference numerals refer to like parts throughout the several views and in which:

FIG. 1 is an example flow diagram of the components of an illustrated implementation of a system and method for a MTP funds transfer.

FIG. 2 is an example flow diagram of a general overview of an illustrated implementation of the system and method for a MTP funds transfer.

FIG. 3 is an example flow diagram of the retail location to retail application flow, using a stored value reloadable pack, of an illustrated implementation of the system and method for a MTP funds transfer.

FIG. 4 is an example flow diagram of the website to existing prepaid card flow of an illustrated implementation of the system and method for a MTP funds transfer.

### DETAILED DESCRIPTION

The present disclosure relates to electronic funds transfer, and more particularly relates to a system and method that provides intra-national and/or international electronic funds transfer. More particularly still, the present disclosure relates to a system and method that provides intra-country and/or international electronic funds transfer supporting multiple fund-in (“cash-in”) and fund-out (“cash-out”) options using a money transfer platform (MTP). A MTP can be, in some implementations, a peer-to-peer (P2P) or other decentralized and distributed network. In other implementations, a MTP can be any network structure and/or configuration capable of performing functionality described in the present disclosure.

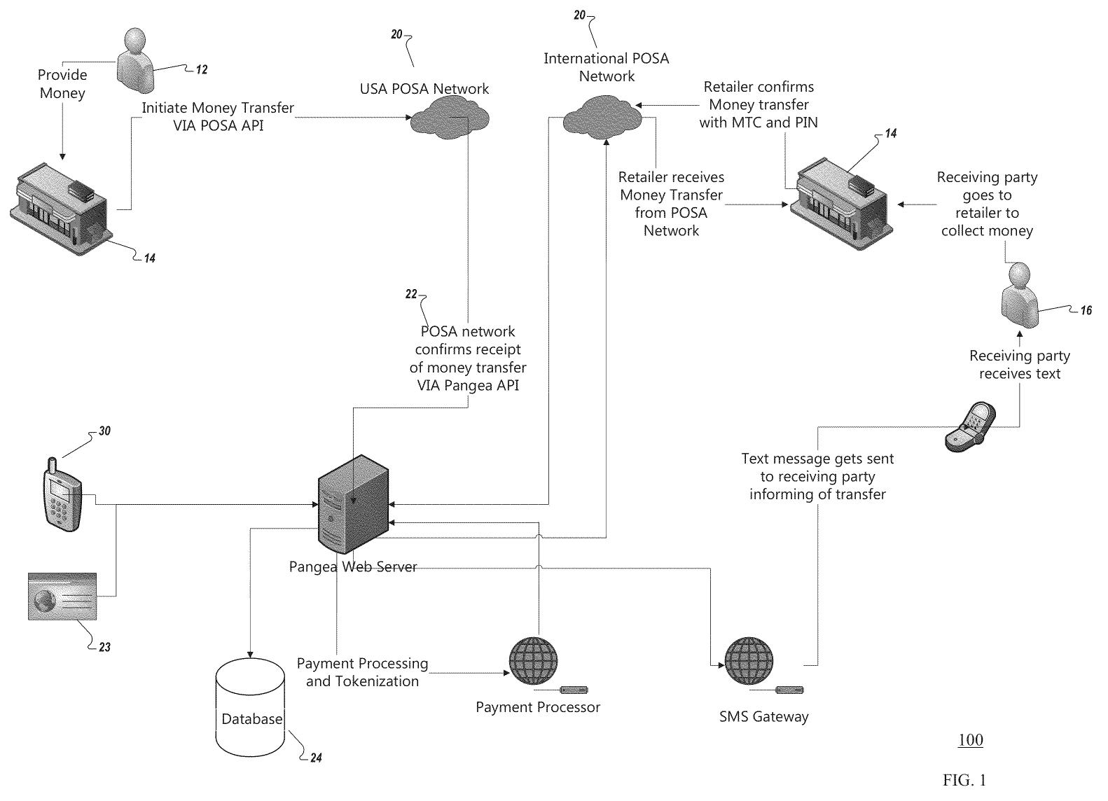

The system and method for a MTP funds transfer may comprise a MTP system that provides a low-cost suite of financial service products using a website, mobile application, and/or retail locations. Example system 100, shown in FIG. 1, provides a mechanism to seamlessly transfer stored value across retail networks and card programs. The example system 100 platform acts like a clearing house in that the platform includes components that handle settlement and reconciliation for the point-of-sale activation (POSA) networks and funds transactions using a credit line. To utilize the example system 100 platform on a web application 26 and/or a mobile application 30, consumers can, in some implementations, link a mobile phone number and a funding source, such as a prepaid debit card, to an example system 100 account. In these implementations, consumers wanting to fund a transaction with cash use the example system 100 platform at a retail location, and then link a mobile phone number to a transaction.

One or more implementations of example system 100 also provides basic consumer functionality, such as account creation and management, provides the ability to interact with third party fraud detection services, as well as the system's own fraud prevention service, to validate transactions in real-time, provides merchant processing, provides short message service (SMS) and voice confirmation once services are completed, provides consumer transaction tracking and customer support, provides settlement with consumer accounts and merchant accounts, provides data storage of know-your-customer (KYC) information and compliance (e.g., anti-money laundering (AML) and office of foreign asset control (OFAC) requirements), and provides a mobile software application that will provide a code (e.g., 2D, QR, or barcode) that can be read by point-of-sale (POS) terminals to facilitate quicker transactions at retail locations and that will also be backward compatible with the a phone number or other identifier associated with the customer account. Example system 100 also has the ability to interface with many external application programming interfaces (API) of channel partners, such as POSA networks and prepaid processors, to facilitate the transfer of value across networks.

Example system 100 uses the POSA network 20 within the retail payment ecosystem by integrating into the retail payment ecosystem, such as POS terminals and processors, through existing prepaid activation rails. Prepaid activation rails include, in some implementations, prepaid cards, for example those at retail stores. The prepaid cards, when not purchased, are essentially un-activated debit card accounts. When purchased, the cards are activated by a prepaid network. The system used to activate the card from the POS system in retail all the way to the database of record from the card issuer would be a “prepaid activation rail.” Example system 100 provides software interconnectivity across prepaid retail networks enabling “closed loop” systems to speak to each other. In some implementations, “closed loop” refers to a stored value card (e.g., gift cards) that is only spendable at a particular retailer (e.g., Wal-Mart gift card, etc.). Example system 100 can also facilitate “open loop” transfer capability across the networks and will provide AML, OFAC, and compliance support for participating retailers. “Open loop,” in some implementations, is a reference to a stored value card that can be spent at any merchant processing agreement (e.g., through Visa, MasterCard, American Express, etc.). Retail locations can use their existing POS terminals, such as those provided by Ingenico, Verifone, and the like.

In some implementations, example system 100 additionally offers remote deposit capture that includes the ability, among others, to scan an image of a check online or through the mobile application and deposit funds directly onto a prepaid card, limiting the need to use check cashing locations. Example system 100 can also offer bill-pay functionality that supports payments to utility companies, water companies, cable providers, department stores, banks, credit card companies, wireless service providers, or any other payee. In some implementations, the bill-pay feature is available through the mobile application and online user interface.

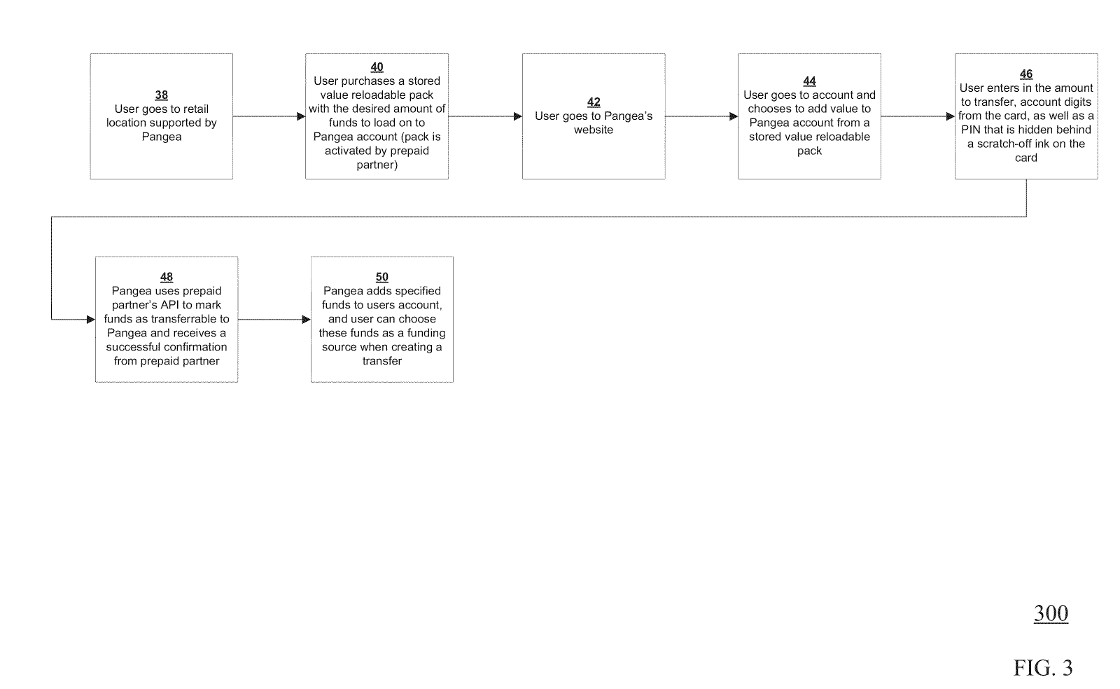

In some implementations, a customer can transmit funds to anyone in a few steps either online, through the mobile application, or in-person at a retail location. The sender 12 can initiate a funds transfer through interactions with a sales associate at a retail location 14 (also shown in FIG. 3), and a custom example system 100 graphical user interface on the POSA software or through an example system 100 webpage on the POS hardware. The sender 12 will then provide the sales associate with the sender's name, phone number, receiver's 16 name, receiver's 16 phone number, the amount of funds to transfer, cash or any other form of payment, and/or a transfer pincode (e.g., a “PIN” transferred between retailer 14 to an international POSA network 20). In some implementations, the transfer pincode can be communicated to a receiver by a sender directly and displayed to (and in some instances chosen by) the sender in a mobile application). The sales associate will enter the data into an example system 100 user interface on their POS device, show the sender 12 the confirmation screen showing the transfer detail and if the sender 12 approves the transaction, the sales associate may charge the sender 12 the appropriate amount to fund the transfer and the fees associated with the transaction. In certain implementations, the POS device will communicate with the POSA network 20 that is integrated with the system's 100 external API 22. The POSA network 20 will make a request to the example system 100 and the example system 100 may create an active transfer in the example system 100, record all data necessary to orchestrate a transfer of funds from the POSA network 20 to the example system 100, and/or return the POSA network 20 with the data necessary for the retailer 14 to give the sender 12 the transaction identifier, the money transfer code (MTC) 26 (or receiver code/transfer identifier—e.g., sent to a receiver 16 using a SMS message), the transfer pincode, the transaction amount in originating and terminating currencies (which may be the same currency), the conversion rate, and/or the fee amount. The sales associate will give the sender 12 a receipt and the example system 100 will then send an SMS message and/or email to the sender 12 and the receiver 16, notifying them that the money transfer is active in the system 10 and can be retrieved.

In some implementations, if the receiver 16 is getting a new card, the sender's 12 funding source is charged the amount of the transfer and fees. If this is an instant transfer from a bank, the funds will be deposited into the system's 100 settlement account. If this is a credit card charge, the funds will be processed by a payment processor, and when released will enter the system's 100 settlement account. After the transfer is successfully processed, the transfer will become live in the system's 100 database 24 and is accessible by any POSA network 20 partner that is integrated with the system's 100 external API 22. To reload a receiver's 16 existing account, the sender's 12 funding source is charged and the example system 100 contacts the API of the POSA network 20 to reload the general purpose reloadable (GPR) card by the amount charged.

In some implementations, the sender 12 contacts the receiver 16 and gives them the transfer pincode. Sending the receiver 16 the MTC 26 and the transfer pincode in two separate communications prevents an unintended recipient from receiving the funds. When the receiver 16 goes to a retail store 14 that uses a POSA network 20 integrated with the example system 100, the receiver will instruct the sales associate that they are receiving a payment and will need to provide the sales associate with the receiver's 16 name, phone number, the MTC 26 and the transfer pincode. The sales associate will enter this data into the POS device using an example system 100 user interface. Once submitted, the example system 100 will make a request to the POSA network's 20 API, which is integrated with the example system's 100 external API 22. The POSA network 20 will make a request to the example system 100 to determine if there is an active transfer matching the data entered into the example system 100. If so, the example system 100 will return the necessary data and coordinate the transfer of money and fees to the POSA network 20 and the POSA network 20 will activate a GPR card or a one-time use card at the retail location 14. If a GPR card is used, data regarding this account, including a token for referencing the account in future transactions, may be provided to the example system 100 using the API 22. The receiver 16 can then receive an activated pre-paid card with the amount of the transfer loaded onto it.

In some implementations, the sender 12 can initiate a funds transfer by scanning an example system 100 one-time activation gift card at the retail location 14, where the sender 12 will purchase the gift card with fees at the time of sale and use the gift card to initiate a web or mobile application transfer with credit from the gift card. In some implementations, the sender 12 can also initiate the transfer by scanning a code (e.g., 2D, QR, or barcode), or entering a number from a native/web mobile application and loading value to the sender's 12 example system 100 account. The sender 12 will then use this value to initiate a web or mobile funds transfer.

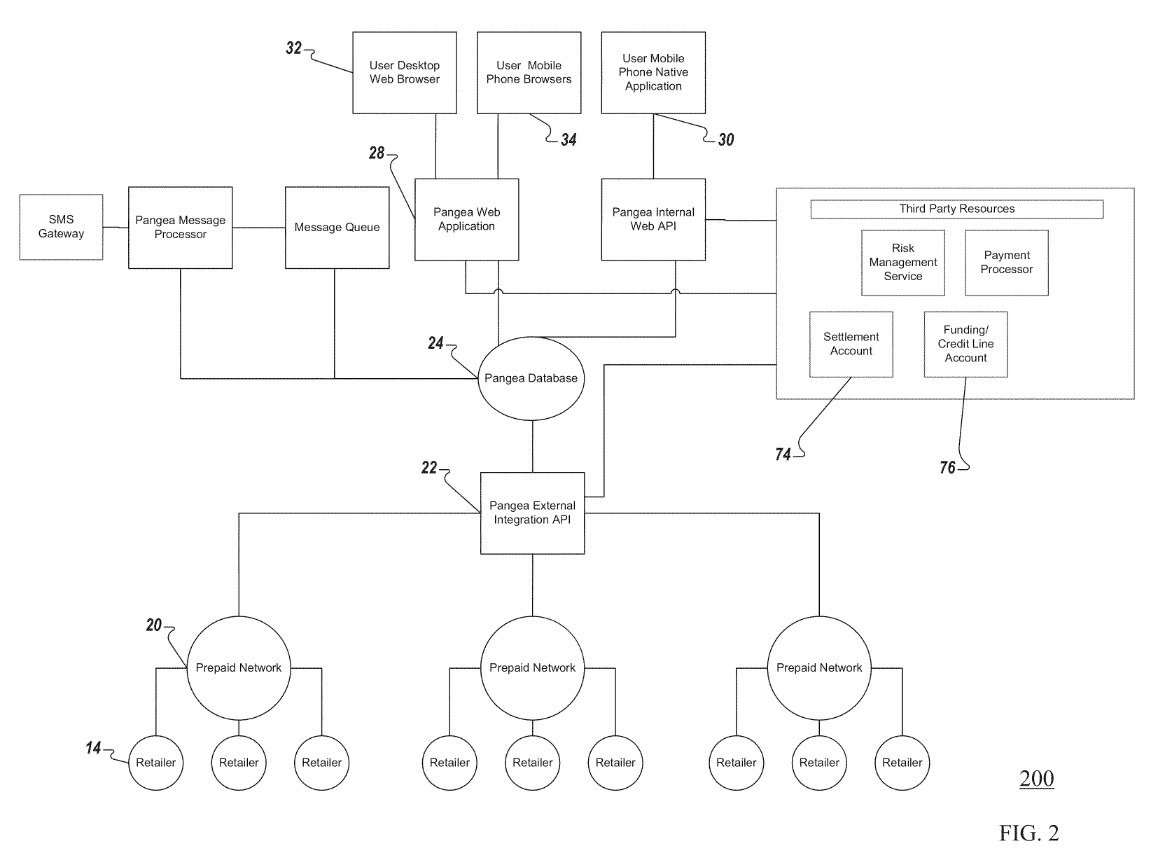

In the example system shown in FIG. 2, a user desktop web browser 32 and a user mobile phone browser 34 accesses a Pangea (e.g., MTP) web application in order to interact with the MTP system. In some implementations, the user mobile phone native application 30 can communicate with the Pangea internal web API (e.g., Pangea/MTP mobile API) in order to interact with the MTP system. The Pangea web application 28 and Pangea external integration API (e.g., a partner API) 22 store and fetch data from the Pangea database 24. The Retailer 14 connects to the prepaid network partner 20, which in turn can connect to the Pangea external API 22 in order to coordination transfer cash payouts. The funding/credit line account 76 is used to pay to the foreign exchange partner in order to prefund transfers in a destination country/location. The settlement account 74 is used to receive funds from the network partner from cash-ins, and reimburse the funding/credit line account 76.

Turning now to the example method shown in FIG. 2, in some implementations, the sender 12 can also initiate by going to a retail location 38, shown in FIG. 2, and purchasing a stored value reloadable pack, which is activated by a prepaid partner, with the desired amount of funds to load onto the example system 100 account 40. The sender 12 then goes to the example system's 100 website 42 and logs into his or her account. Once logged in, the sender 12 chooses to add value to his or her account from a stored value reloadable pack 44. The sender 12 enters in the amount to transfer, the account digits from the card, and the PIN that is hidden behind scratch-off ink on the back of the card 46. The example system 100 uses the prepaid partner's API to mark funds as transferrable to the example system 100 and receives a successful confirmation from the prepaid partner 48. The example system 100 then adds the specified funds to the sender's 12 account and the sender 12 can choose these funds as a funding source when creating a web or mobile application funds transfer 50.

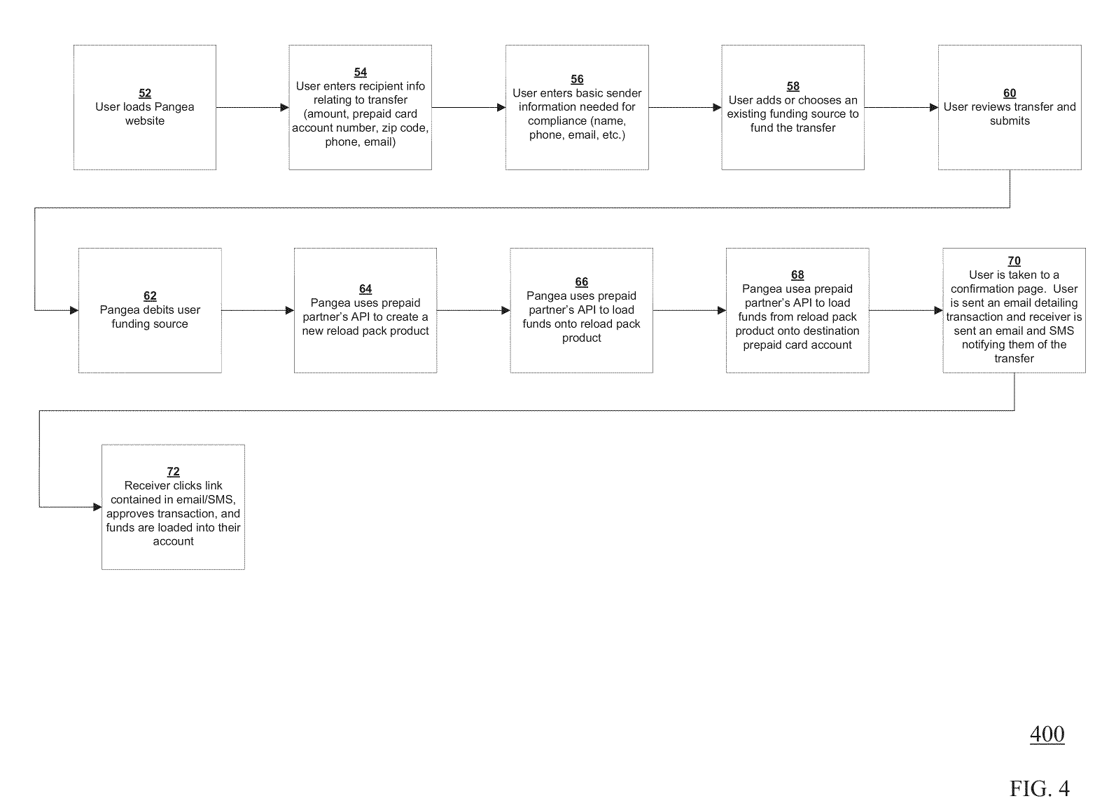

To initiate a transfer online or through a mobile application, an example method shown in FIG. 4, the sender 12 loads the example system's 100 website 52 and the sender 12 can either log into his or her account or initiates a transaction without an account. The sender 12 then enters the basic KYC information for the transaction. If the receiver 16 has a single card on file in the example system 100, the sender 12 then enters the recipient's 16 information relating to the transfer 54, such as the receiver's 16 name, phone number, the amount to transfer, the card account number, zip code, and/or email address. The sender 12 enters his or her own basic information 56, which is needed for compliance, such as the sender's 12 name, phone number, and/or email address. The sender 12 will also enter a password and an account will be created in the example system 100. The sender 12 then adds or chooses an existing funding source to fund the transfer 58. The sender 12 reviews the transfer and submits the transfer for processing 60. The example system 100 debits the sender's 12 funding source 62 and uses the prepaid partner API to create a new reload pack product 64. The example system 100 uses the prepaid partner's API to load funds onto the reload pack product 66 and then to load funds from the reload pack product onto the destination prepaid card account 68. The sender 12 is then taken to a confirmation page, the sender 12 is sent an email detailing the transaction, and the receiver 16 is sent an email and SMS message notifying them of the transfer 70 and will include a URL allowing the receiver 16 to accept the funds transfer to their account. The receiver 16 at 72 clicks the link contained within the email or SMS message, approves the transaction, and the funds are loaded onto their account. If the receiver 16 has multiple cards on file in the example system 100, the receiver 16 can choose the card on file on which to load the funds.

In the example method, if the receiver 16 does not have a card on file in the example system 100, the sender logs into the system's 100 website 28 (shown in the example method of FIG. 2), or uses the example system 100 as a guest, and the sender 12 enters basic KYC information, such as their name, phone number, password and an optional email address. The sender 12 submits the KYC information, an account is created, the sender 12 is logged into the example system 100 and is redirected to the transaction landing page. The sender 12 then initiates a transaction and enters the details for the transfer, including the amount to transfer and chooses the payment method, if it's already linked to the sender's 12 account, or enters a new payment method if that payment method is not already linked to the sender's 12 account. If entering a new payment method, the account details are sent to the payment processor directly and tokenized into a card or customer token, allowing for minimal PCI scope of the example system 100 application. The example system 100 requires the sender 12 to enter the payment details, such as the card number, card security code, the expiration date, and the billing zip code when entering a new payment method. The token is saved in order to keep a list of linked payment methods for the sender 12 to choose from in the future. The sender 12 then enters the receiver's 16 name, phone number, and the transfer pincode and submits the transaction. The sender 12 is then directed to the confirmation page, displaying the status of the transaction and the status of the notification. The system generates the MTC 26 and will send a notification of the transfer with the MTC 26 to the receiver 16 using SMS message or email.

In the example method, if the receiver 16 has multiple cards on file, the receiver 16 can be required to contact the example system 100, by logging into the website 28 or mobile application 30 (refer to FIG. 2), and to select the card in which to load the funds. The receiver 16 will use one of the cards issued in previous transfers, allowing the example system 100 to directly load funds onto that card in real time. Alternatively, the receiver 16 can obtain a new card by using a retailer location map. The retailer location map is a searchable interactive web-based map similar to a locations map displayed in the mobile software application (e.g., similar to FIGS. 19-20) with geo-location capability. The retailer location map allows the receiver 16 to find all locations in a region or all locations closest to him or her. The receiver 16 then goes to the retail store of their choosing and chooses a pre-paid card to have the retailer activate and load the amount of the transferred funds.

The foregoing description of an illustrated implementation of the disclosure has been presented for purposes of illustration and description, and is not intended to be exhaustive or limiting to the precise form disclosed. The description was selected to best explain the principles and practical application of the principles to enable others skilled in the art to best utilize the described subject matter in various implementations and various modifications as are suited to the particular use contemplated. It is intended that the scope of the disclosure not be limited by the specification, but be defined by the claims set forth below.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a field programmable gate array (FPGA), or an application-specific integrated circuit (ASIC). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a cathode ray tube (CRT), liquid crystal display (LCD), light emitting diode (LED), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an API and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations, but rather as descriptions of features that may be specific to particular implementations of the described subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure. Thus, it is to be understood that, within the scope of the appended claims, the disclosure may be practiced otherwise than is specifically described above.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various implementations and various modifications as are suited to the particular use contemplated. It is intended that the scope of the disclosure not be limited by the specification, but be defined by the claims set forth below.

What is claimed is:

1. A method of electronic funds transfer, comprising:
receiving a funds transfer transaction request for transferring funds from a first location to a receiver in a second location, the funds transfer transaction request associated with a funds pack credited with an amount of funds;
requesting, by operation of a computer, validation of a unique identifier associated with the funds pack from a first payment network provider associated with the first location;
receiving, by operation of a computer, a validation success notification responsive to the requested validation of a unique identifier from the first payment network provider;
generating, by operation of a computer, a termination identifier identifying the funds transfer transaction request;
transmitting the termination identifier to the receiver;
providing instructions, by operation of a computer, causing funds to be paid to the receiver upon presentation of the termination identifier; and
receiving a request for funds from a second payment network provider associated with the second location, the request for funds associated with payment of funds based on presentation of the termination identifier.

2. The method of claim 1, further comprising initiating a fund-in process for the funds transfer transaction request using the funds pack.

3. The method of claim 1, further comprising transmitting geographic locations that may be used by the receiver to receive the funds.

4. The method of claim 3, wherein a mobile software application initiates a display of the transmitted geographic locations.

5. The method of claim 1, further comprising storing data regarding the termination identifier and data associated with the funds transfer transaction request.

6. The method of claim 1, further comprising:
receiving the unique identifier associated with the funds pack and an amount of funds to credit to the funds pack; and
storing the unique identifier and the amount of funds to credit to the funds pack to a database.

7. The method of claim 6, further comprising initiating a funds transfer process to transfer a particular amount of credited funds from the first location to the second location.

8. The method of claim 7, further comprising generating instructions to:
convert the particular amount of credited funds into a different currency type; and
credit the different currency type to the second payment network provider.

9. A method of electronic funds transfer, comprising:
receiving an indication of an interest in transferring funds from a sender at a first location to a receiver at a second location;
receiving an indication of an initial funds transfer amount in a first currency for transfer to a receiver at the second location;
identifying a currency exchange rate value for an exchange of a first currency used at the first location and a second currency used at the second location;
converting, using the currency exchange rate, the initial funds transfer amount into an funds receiving amount as measured in the second currency; and
communicating the funds receiving amount.

10. The method of claim 9, further comprising transmitting a funds transfer transaction request to a MTP transfer service, the funds transfer transaction request associated with a funds pack credited with an amount of funds for transfer from the first location to the receiver.

11. The method of claim 9, further comprising initiating a display of geographic locations available for the receiver to receive funds near the second location.

12. The method of claim 9, further comprising initiating a funds transfer transaction request for transferring funds from the first location to the receiver.

13. The method of claim 9, wherein the first currency is different than the second currency.

14. The method of claim 9, wherein the first location is in a country that is different than the country in which the second location is located.

15. The method of claim 9, further comprising identifying the currency to be used as the second currency transferred to the receiver at the second location.

16. A method of electronic funds transfer, comprising:
receiving from a point-of-sale (POS), by operation of a computer, a code associated with a fund-in transaction;
receiving, by operation of a computer, a transfer amount and a unique transfer identifier;
transmitting the transfer amount and the unique identifier to a money transfer platform (MTP) transfer service;
receiving an activation response from the MTP transfer service, the activation response responsive to the MTP transfer service:
validating, by a computer, the identified transfer;
activating the transfer; and
alerting a receiver uniquely identified by the unique transfer identifier; and
transmitting an activation response to the POS.

17. The method of claim 16, wherein the code includes one of a linear code or a matrix code.

18. The method of claim 16, wherein the receiver is uniquely identified by at least one of a telephone number, an address, a government issued identifier, or an employer issued identifier.

19. The method of claim 16, further comprising the POS requesting and receiving the transfer amount responsive to receiving the code.

20. The method of claim 19, wherein the POS receives the code from a mobile computing device.

21. The method of claim 19, further comprising the POS processing the received code.

22. The method of claim 16, wherein the MTP transfer service exposes an application programming interface (API) for receiving a request containing the code.
